(19) United States
(12) Patent Application Publication
(10) Pub. No.: US 2022/0056725 A1
(43) Pub. Date: Feb. 24, 2022

(54) MODULAR SYSTEM OF CONSTRUCTION, CONDUCTION AND FIXATION OF TUBULAR STRUCTURE ELEMENTS AND CORRESPONDING TUBULAR STRUCTURE

(71) Applicant: Frank Bollmann, São Bento do Sul (SC) (BR)

(72) Inventor: Frank Bollmann, São Bento do Sul (SC) (BR)

(21) Appl. No.: 17/275,963

(22) PCT Filed: Sep. 13, 2019
(86) PCT No.: PCT/BR2019/050394

§ 371 Date: Mar. 12, 2021

(30) Foreign Application Priority Data
Sep. 13, 2018 (BR) 102018068589-9

(51) Int. Cl. E04H 12/08; F16B 7/04; E04H 12/34

(52) U.S. Cl. CPC E04H 12/085; E04H 12/342; F16B 7/0406

(57) ABSTRACT

The present invention relates to a modular system of construction, conduction and fixation of tubular structure elements, comprising a first module (200), a second module (300) and, optionally, one or more additional modules (n), wherein each module (200, 300, n) comprises, in the region of its upper end, an annular fixing flange (230, 330) and crimp fins (240, 340) arranged inside the upper end at a fin distance (P₂₄₀) which is equivalent to a crimping depth (P₂₀₀, P₃₀₀) decreased from 10 to 100 millimeters, preferably from 50 millimeters. The crimping depth (P₂₀₀, P₃₀₀), in turn, corresponds to a value between 0.5 and 3, preferably 1.5, times the diameter measurement (D₂₀₀, D₃₀₀) of the corresponding module (200, 300). The present invention also relates to a corresponding tubular structure (150).

### FIELD OF APPLICATION

The present invention belongs to the field of mechanical engineering, notably of elements for the construction of masts, poles, towers and the like.

### INTRODUCTION

The present invention relates to a modular system of construction, conduction and fixation of tubular structure elements and to a corresponding tubular structure, in which said tubular structure is formed by tubular elements crimped in each other, intended for the construction of any elongated tubular structure, preferably masts, poles, towers and the like, especially poles for electric power transmission, telecommunications, data transmission and the like.

### STATE OF THE ART

There are different systems and constructive types of tubular structures, specifically poles or masts intended to carry electric power transmission lines, telecommunications, data transmission and the like, having among other characteristics, the one of being of high height. It should be noted that high height, in the present description, designates, but in a non-limiting manner, poles or masts over 15 meters high.

The most common building form for poles or masts of high height, according to the present invention, contemplates reinforced concrete tubular poles that, after a certain length, are divided into segments to facilitate and even enable the transport and handling thereof.

These concrete poles, however, have several disadvantages, starting with their high weight, which demands the use of large capacity cranes for their lifting and handling for transportation and installation. Even when the larger concrete poles are divided into segments, the resulting segments remain extremely heavy. Adding to this characteristic are also the difficulty and cost of the connection of the respective segments to each other.

Another problem is the micro-cracks or cracks in the concrete structure when subjected to transportation and, especially, to operating loads, causing moisture to penetrate the concrete structure's body, reacting with the steel of its mooring and compromising its mechanical strength, which becomes a bigger problem in coastal regions where the reaction is more accelerated due to salt air.

Another problem with high height concrete poles results from the base diameter, which is of high proportions and which is negatively reflected especially in urban areas, where these models hinder or even obstruct the passage of pedestrians on sidewalks, occupying precious and valuable space in the soil.

Concrete poles of this size demand extremely high precision in the installation, especially with regard to the angular position of the holes or crosspiece fixing devices, which, if out of position, will require costly rework and may even compromise the installation's progress.

Last but not least, for concrete tubular structures of high height, mention should be made of the resistance of the external structures of the concrete poles to air currents as a whole, as they are rough due to the characteristics of the material from which they are made. Such resistance increases the load on the concrete poles, reducing the alternatives for weight optimization and increasing the risk of resonance frequencies.

Alternatives to concrete poles and masts are their prior art equivalents built using concrete and other materials such as metals and alternatives made purely in metal, more specifically in steel, but which also have some drawbacks and disadvantages to be overcome.

An example of a high height structure that mixes steel and concrete is described by patent document U.S. Pat. No. 4,242,851, which reveals a modular pole formed by hollow steel elements joined together through annular concrete bodies arranged at the ends of the elements. Although there is a significant reduction in weight in relation to the concrete models and relative flexibility adjustment by torsion, especially of the last and highest segment, there is still the difficulty of joining the modules through the concrete, a highly disadvantageous feature, especially in the practice of in-field installation. There is also no reference to any form of alignment between the tubes for the constitution of the modules.

An example of a steel pole is disclosed by the patent document U.S. Pat. No. 8,302,368, which shows a pole formed by hollow and tapered steel elements with ends that allow them to fit together, with the fixation of a module on another intended through transverse screws. There is here a clear limitation on the possible height of a structure of this nature, both by the way of fitting and the way of fixing. In addition, the document makes it clear that one of the objects of the invention is to achieve the lowest possible crimping depth (L) in order to save material. The shear stresses of screw fixings such as the one described herein also prevent greater loads and, therefore, limit their height as well. Finally, no means of guiding and centering the tubes are disclosed to assist and facilitate the assembly of the modules.

Another example of a steel pole is disclosed by the patent document U.S. Pat. No. 1,870,770, in which is described a structure formed by hollow and tapered steel modules, fitted together by pressure and fixed together by external fixing elements projecting from the structure. One of the disadvantages of this type of solution is exactly related to the protrusion of the fixing elements and the mounting limitations related to them in higher structures. In addition, the foreseen crimping method limits the length of the individual modules, increasing the number of modules necessary for higher constructions. This last phenomenon can also be verified in the solution disclosed by the patent document U.S. Pat. No. 3,865,498.

Alternative forms of construction and fixation of steel poles are disclosed, for example, in patent document WO 2011 06526, which discloses poles formed by several perimeter plates arranged around concentric rings, in patent document CN201236515Y, which discloses modules connected to each other by flanges, but without any form of centralization or orientation of assembling or crimping and, finally, in the patent document EP 2 192 245, which reveals modular segments fixed among themselves by flanges, but inside the structure, also without any form of centralization or specific orientation of assembling or crimping.

Finally, mention should be made of the lattice towers, which are very common in transmission lines, but which have as main limitations the area they use on the ground (reaching in some cases more than 100 m²) and the assembling time, much longer than that of metal poles, due to the high number of components and their joints and fixings. Due to its size and constructive disposition, it is also difficult to use lattice towers in urban areas, for example, on sidewalks.

There is, therefore, space for a modular system of construction, conduction and fixation of tubular structure elements, especially of high tubular structures, which provides tubular structures such as poles, masts and high towers that are extremely robust, relatively light, easy to transport, handle and assemble, which have means of guidance, centralization and conduction for the assembly, and that these means guide the assembly of the individual modules with each other in an appropriate and unequivocal way, which allows the angular adjustment especially of the highest module, lowest module of easy fixation on the ground without the need for crimping it and of less wind resistance.

### OBJECTS OF THE INVENTION

The object of the present invention is, therefore, to provide a modular system of construction, conduction and fixation of tubular structure elements and a corresponding tubular structure.

### BRIEF DESCRIPTION OF THE FIGURES

For a better understanding and visualization of the object of the present certificate of invention addition, it will now be described with reference to the attached figures, representing the technical effect obtained through exemplary embodiments not limiting the scope of the present certificate of invention addition, in which schematically:

FIG. 1: shows a side view of a modular system of construction, conduction and fixation of tubular structure elements according to the invention;

FIG. 2: shows an enlarged side view and partly in section of the detail A of FIG. 1;

FIG. 3: shows detail A of FIG. 1 in an enlarged perspective;

FIG. 4: shows an enlarged side view of two modules according to the invention in a crimping situation;

FIG. 5: shows a side view of a crimp fin according to the invention;

FIG. 6: shows a front view of the crimp fin of FIG. 5;

FIG. 7: shows a perspective view of a variant of the system according to the invention, without the use of a dimensional stabilization ring;

FIG. 8: shows an upper view of a module according to the invention, with the annular fixing flange, partially transparent to better represent the crimp fins;

FIG. 9: shows a partial perspective view of the base of a module according to the invention;

FIG. 10: shows a schematic representation of prior art transmission towers, possible free interspaces and effects of deforestation necessary for their use; and

FIG. 11: shows a schematic representation of tubular structures according to the invention, possible free interspaces and their use without the need for deforestation.

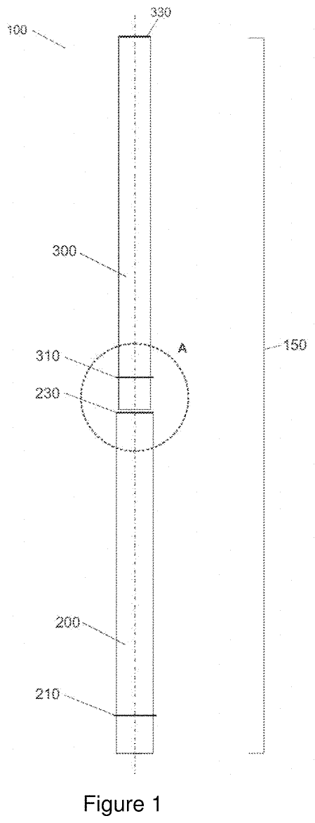

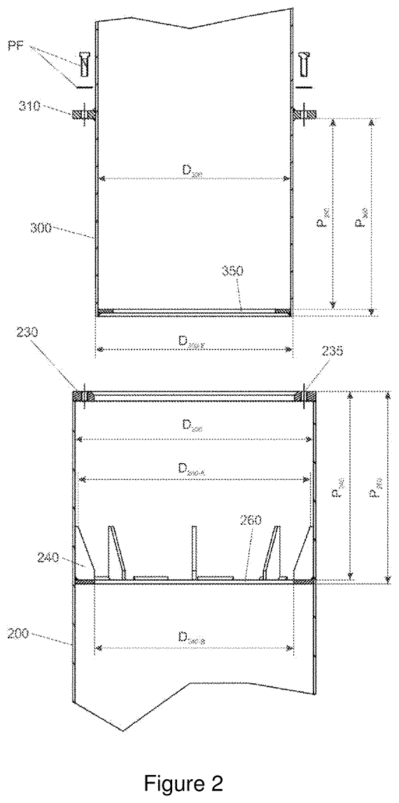

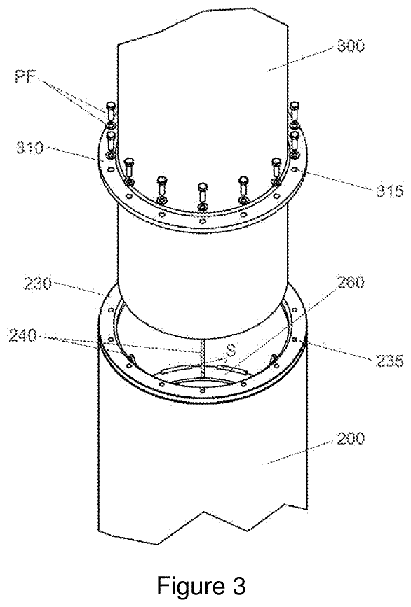

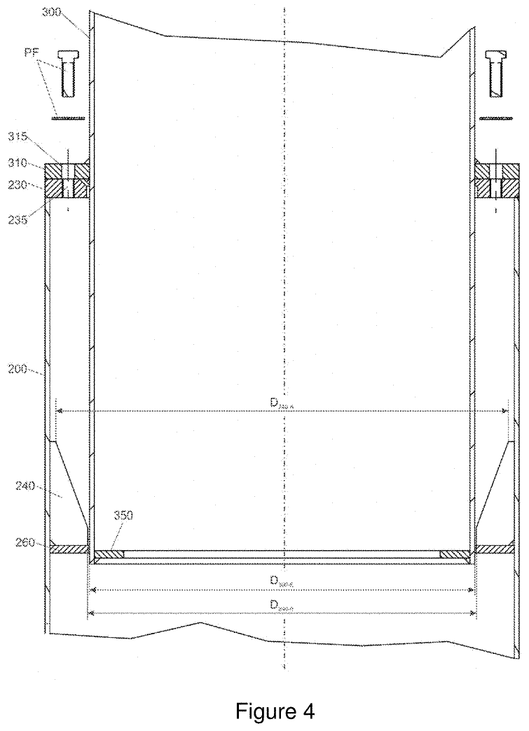

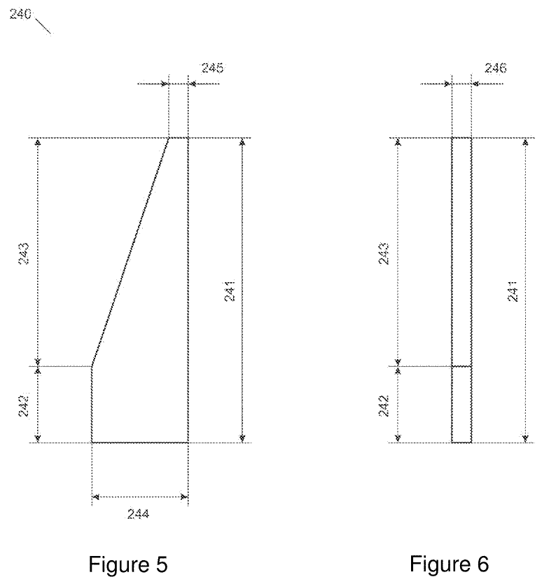

### DETAILED DESCRIPTION OF THE INVENTION

The attached figures show a modular system of construction, conduction and fixation of tubular structure elements or, simply, just modular system (100), in addition to a corresponding tubular structure (150).

A modular system (100) according to the invention comprises one or more modules (200, 300) crimped together to form a tubular structure (150).

Each module (200, 300), preferably a metal tube, has in the region of its lower end a fixing crown (210, 310) provided with two or more through or threaded holes or the like (215, 315), preferably arranged in a equidistant manner along its perimeter face, wherein said fixing crown (210, 310) is positioned at a distance from the lower end of the module (200, 300), herein called the crimping depth (P₂₀₀, P₃₀₀), the measurement of which corresponds to a value between 0.5 and 3.0, preferably 1.5, times the diameter measurement (D₂₀₀, D₃₀₀) of the module (200, 300).

In the region of its upper end, each module (200, 300) has an annular fixing flange (230, 330) provided with through or threaded holes or the like (235, 335) and which covers the entire perimeter of this upper end, in addition to crimp fins (240, 340) arranged inside the upper end at a fin distance (P₂₄₀) which is equivalent to a crimping depth (P₂₀₀, P₃₀₀) decreased from 10 to 100 millimeters, preferably from 50 millimeters, in which the crimping depth (P₂₀₀, P₃₀₀), in turn, corresponds to a value between 0.5 and 3, preferably 1.5 times the diameter measurement (D₂₀₀, D₃₀₀) of the corresponding module (200, 300).

The crimp fins (240, 340) serve to guide, center and conduct with precision the crimp of a smaller second module (300) into a larger first module (200), until the fixing crown (310) abuts the annular fixing flange (230), which serves as a vertical stopper for the smaller second module (300).

The crimp fins (240, 340) are preferably polygonal in shape, having a total height (241, 341) composed of the sum of a lower height (242, 342) and a higher height (243, 343), a larger lower width (244, 344) and a smaller upper width (245, 345), in addition to a thickness (246, 346).

For the purpose of facilitating the description and understanding of the present invention, reference will be made alternately to one or two of the modules (200, 300) and their components, depending on the greater or lesser complexity of the explanation. In any case, what will apply to the elements of the larger module (200) will also apply to the elements of the smaller module (300) and vice versa.

The measurements of the crimp fins (240) are such that the diameters formed between the edges facing into the tube of the larger module (200), specifically of a higher diameter (D_{240-A}) formed between the edges of the smaller upper width (245) and a lower diameter (D₂₄₀₋₈) formed between the edges of the larger lower width (244), are such that the lower diameter (D₂₄₀₋₈) represents between 80 and 90%, preferably 85%, of the higher diameter (D_{240-A}); the higher diameter (D_{240-A}) represents between 85 and 99%, preferably 97%, of the inner diameter of the larger tube (D₂₀₀); and the lower diameter (D_{240-B}) is between 0.25 and 1.5%, preferably 0.85% greater than the outer diameter of the smaller tube (D_{300-E});

In addition, to allow smooth conduction of the module (300) inside the larger module (200) during the crimping, the measures of the crimp fins (240) must be such that the higher height (243) is between 65% and 85%, preferably 75%, of the total height (241), with the smaller height (242) representing between 65 and 85%, preferably 77%, of the larger lower width (244), the measurement of which respects the relations and proportions defined above for both the higher diameter (D_{240-A}) and for the lower diameter (D₂₄₀₋₈).

The crimp fins (240) must be arranged in a spaced and equidistant manner along the internal perimeter of the modules (200, 300), wherein the crimp fins (240) arranged parallel to the longitudinal axis of the modules (200, 300) forming a kind of internal crown and, among themselves, an angle (δ) that can vary according to the diameter and thickness of the tubes of each module (200, 300), this angle (δ) being typically from 5 to 45°.

Once it is crimped and abutted, the position of the smaller module (300) can be adjusted by rotating it inside the bearing formed by the upper end of the first module (200), by the crimp fins (240), and by the annular fixing flange (230), until the through or threaded holes or the like (315, 235) coincide and the union can be completed by fixing the modules (200, 300) through suitable fixing elements (PF). It should be noted that the rotation of the smaller module (300) can also serve to adjust the position of any additional parts fixed to the tubular structure (150), such as, for example crosspieces, insulators, transformers and the like (not shown).

To ensure the maintenance of the circularity of the lower end of each module (200, 300), each module (200, 300) can be equipped with a lower dimensional stabilization ring (250, 350), fixed inside it at a stabilization distance (P₂₅₀, P₃₅₀) which is equivalent to a crimping depth (P₂₀₀, P₃₀₀) decreased from 10 to 100 millimeters, preferably from 50 millimeters, in which the crimping depth (P₂₀₀, P₃₀₀), in turn, corresponds to a value between 0.5 and 3, preferably 1.5 times the diameter measurement (D₂₀₀, D₃₀₀) of the corresponding module (200, 300).

At its upper end, each module (200, 300) can also be equipped with a dimensional stabilization ring (260), which will serve as an additional structuring element to the annular fixing flanges (230, 330) or any other ring fixed inside it, or close to the upper end, or at a random distance to be chosen between the upper end and the dimensional stabilization ring (260, 360).

The crumpling or crushing of tube ends is a recurring problem in metal tubes built with relatively small thicknesses in relation to their large diameters. The dimensional stabilization rings (250, 350, 260, 360), together, ensure that the circular shape of the tubes of each module (200, 300) is maintained, especially at its ends, even in severe handling and transport conditions.

The crimp fins (240) can be arranged on the dimensional stabilization ring (260) fixed inside the region of the upper end of each module (200, 300), at a dimensional stabilization distance (P₂₆₀, P₃₆₀) which is equivalent to a crimping depth (P₂₀₀, P₃₀₀) decreased from 10 to 100 millimeters, preferably from 50 millimeters, in which the crimping depth (P₂₀₀, P₃₀₀), in turn, corresponds to a value between 0.5 and 3, preferably 1.5 times the diameter measurement (D₂₀₀, D₃₀₀) of the corresponding module (200, 300).

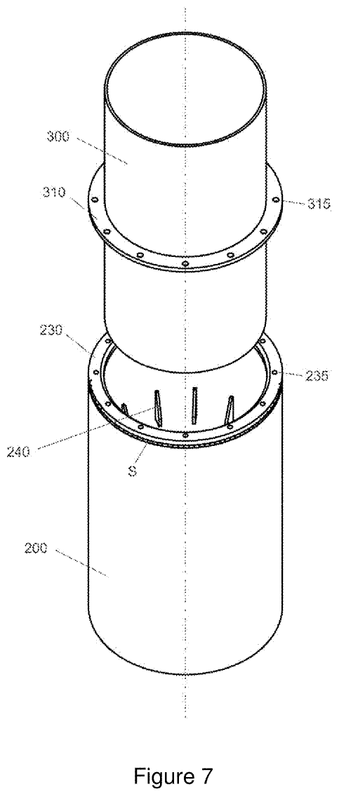

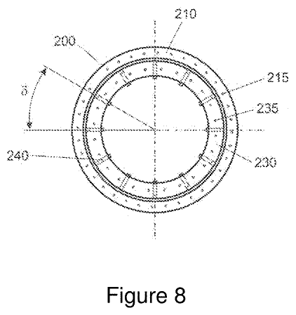

The crimp fins (240) can also be positioned inside the respective module (200) without the presence of a dimensional stabilization ring (260), a situation shown in particular by the attached FIG. 7.

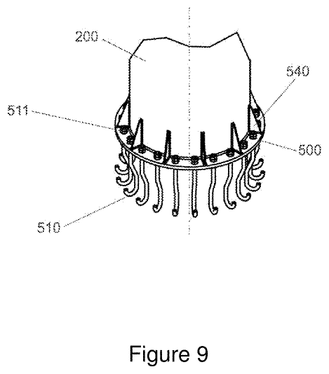

For fixing the tubular structure (150) to a substrate, any suitable means known from the prior art, such as the use of a ground fixing crown (500) to which anchoring hooks (510) can be fastened through fixing elements (511), can be used in the first module, seen from the bottom up. In the current example, the larger module (200) was considered to be the first and external fins (540) were used to assist in structuring the fixation—see attached FIG. 9.

It should also be noted that the tubular structure (150) can be formed by one module (200) or by two modules (300) or by several modules, ending in an upper, terminal or top n-th module (n), forming a tubular structure (150) of several modules (200, 300, n).

All elements added to the modules (200, 300), such as fixing crowns (210, 310), annular fixing flanges (230, 330), crimp fins (240, 340), upper dimensional stabilization rings (250, 350), dimensional stabilization rings (260, 360), must be fixed by appropriate fixing means, which can, for example, be welded through weld beads (S) or any similar suitable to the application and dimensions of the elements.

To allow the crimping of the modules (200, 300) and the assembling of the corresponding tubular structure (150), the diameters (D₂₀₀, D₃₀₀) of the modules (200, 300) must be such that the diameter of a first module (D₂₀₀) is always larger than the diameter of a second module (D₃₀₀), which, in turn, should have a diameter larger than the next adjacent module and so on, up to a last or n-th module (n) of diameter (Do).

The relation between the diameters (D₂₀₀, D₃₀₀, Dₙ) of the modules (200, 300, n) should be chosen in such a way that the diameter of the first module (D₂₀₀) is equal to the measure of the diameter of a second adjacent module (D₃₀₀) plus a suitable value for the diameter, for example between 50 mm and 500 mm, preferably 150 mm.

This transition relation between the diameters will essentially depend on a set of factors such as the tube thickness of each module (200, 300), the crimping conditions, the total number of modules, the segmentation intended for the modules, the applied loads and the respective safety coefficients, the number of fixing elements (PF) etc.

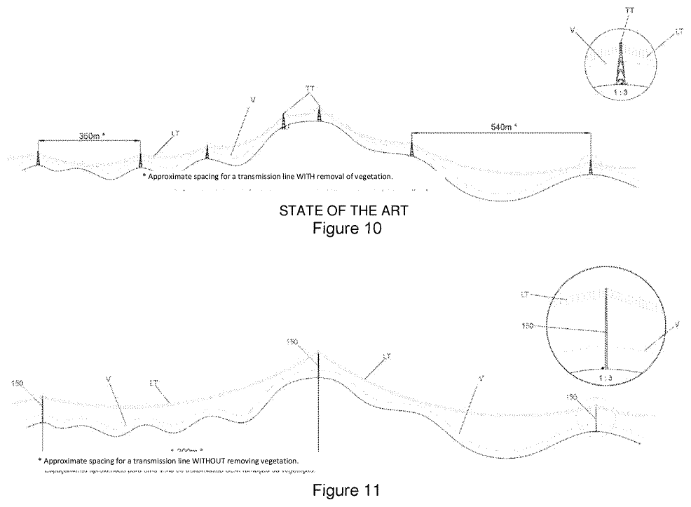

Finally, it should be noted that tubular structures (150) like those of the present invention provide means of building larger and more resistant high structures than their prior art pairs, considerably increasing the possible free interspaces between each structure. In this way, it is possible to drastically reduce the environmental impact, more specifically, to reduce and practically eliminate the need for deforestation of the patches of vegetation (V) under the transmission lines (LT) in relation to what happens in the current case of lattice towers (TT), as shown in the attached FIGS. 10 and 11.

FIG. 10 shows schematically a section of a transmission line (LT) known from the prior art, with interspaces between the lattice towers (TT) that rarely exceed 350 meters and, in some extreme cases, reach 540 meters, but already with great strain on the material.

FIG. 11 schematically shows a section of a transmission line (LT) with tubular structures (150) equipped with seven modules (200, 300, n) crimped according to the invention, allowing, according to the practice of installations already carried out, free interspaces even greater than 1,200 meters, practically dismissing the removal of vegetation (V) under the transmission line (TT).

In a preferred embodiment of the present invention, the modules (200, 300, n) are manufactured in metal, preferably in steel.

In another preferred embodiment of the present invention, the modules (200, 300, n) are coated with polymeric resins or the like, the resin being preferably a polypropylene-based resin or the like.

In yet another embodiment, the modules (200, 300, n) are protected by a galvanizing layer (preferably hot dip galvanizing).

In another embodiment the modules (200, 300, n) are protected by suitable paint, preferably epoxy-based.

### Final Considerations

It is evident that the measures and relation between measures described for the present invention can vary according to the dimensioning of the tubular structure (150). Exhaustive practical tests, however, have shown that these dimensions and their relations are highly efficient and effective in the robustness, safety, and practicality provided by the tubular structure (150). In addition, the construction of the tubular structure (150) of the present invention and said measures and their relations, are highly reliable and reproducible.

### CONCLUSION

It will be easily understood by those skilled in the art that modifications can be made to the present invention without thereby departing from the concepts set out in the description above. Such modifications should be considered to be within the scope of the present invention. Consequently, the particular embodiments described in detail above are only illustrative and exemplary and are not limiting as to the scope of the present invention, which must be given the full extent of the appended claims and any and all equivalents thereof.

1. A modular system of construction, conduction and fixation of tubular structure elements, said modular system comprising a first module, a second module and, optionally, one or more additional modules, wherein each module comprises, in the region of its upper end, an annular fixing flange and crimp fins arranged inside the upper end at a fin distance which is equivalent to a crimping depth decreased from 10 to 100 millimeters, preferably from 50 millimeters, in which the crimping depth corresponds to a value between 0.5 and 3, preferably 1.5, times the diameter measurement of the corresponding module.

2. The modular system according to claim 1, wherein the crimp fins are preferably polygonal in shape, with a higher height measuring between 65% and 85%, preferably 75%, of a total height, with a smaller height representing between 65 and 85%, preferably 77%, of a larger lower width.

3. The modular system according to claim 1, wherein the fins have a higher diameter formed between the edges of the smaller upper width of the fins and of a lower diameter formed between the edges of the larger lower width, where the lower diameter represents between 80 and 90%, preferably 85%, of the higher diameter.

4. The modular system according to claim 1, wherein the higher diameter represents between 85 and 99%, preferably 97%, of the inner diameter of the larger tube and the lower diameter is between 0.25 and 1.5%, preferably 0.85% greater than the outer diameter of the smaller tube.

5. The modular system according to claim 1, wherein the crimp fins are arranged in a spaced and equidistant manner along the internal perimeter of the modules, parallel to the longitudinal axis of the modules forming in between an angle (δ) of 5 to 45°.

6. The modular system according to claim 1, wherein the upper end of the first module, the crimp fins, and the annular fixing flange form a bearing that allows the module, once crimped and abutted, to be rotated in relation to the module.

7. The modular system according to claim 1, wherein each module has a lower dimensional stabilization ring, fixed inside at a stabilization distance which is equivalent to a crimping depth decreased from 10 to 100 millimeters, preferably from 50 millimeters.

8. The modular system according to claim 1, wherein each module, at its upper end, can also be equipped with a dimensional stabilization ring or a ring fixed inside or close to the upper end or at a random distance to be chosen between the upper end and the dimensional stabilization ring.

9. The modular system according to claim 1, wherein the crimp fins can be arranged on the dimensional stabilization ring fixed inside the region of the upper end of each module, at a dimensional stabilization distance which is equivalent to a crimping depth decreased from 10 to 100 millimeters, preferably from 50 millimeters.

10. A tubular structure comprising the modular system according to claim 1, being formed by one module or by two modules, or several of the modules, ending in an upper, terminal or top n-th module (n) being formed by of several of the modules.
